(19) United States
(12) Patent Application Publication
(10) Pub. No.: US 2025/0212055 A1
(43) Pub. Date: Jun. 26, 2025

(54) Wi-Fi Optimization Via Predictive Multi-Access Point Coordination

(71) Applicant: Cisco Technology, Inc., San Jose, CA (US)

(72) Inventors: Malcolm Smith, Richardson, TX (US); Binita Gupta, SAN DIEGO, CA (US); Sukanya Nutakki, Frisco, TX (US); Gino Corleto, HAMBURG (DE); Indermeet Gandhi, San Jose, CA (US)

(21) Appl. No.: 18/595,235

(22) Filed: Mar. 4, 2024

Related U.S. Application Data
(60) Provisional application No. 63/614,902, filed on Dec. 26, 2023.

(51) Int. Cl. H04W 28/02; H04W 28/08; H04W 28/20

(52) U.S. Cl. CPC H04W 28/0289; H04W 28/0273; H04W 28/0983; H04W 28/20

(57) ABSTRACT

Systems, methods, and further embodiments herein relate to optimizing wireless network transmissions. The wireless network may be deployed with a plurality of access points (APs). These APs can be operated or otherwise managed with a multi-access point coordination (MAPC) system. These MAPC systems can pair or otherwise group together multiple APs to work in concert. However, because MAPC can utilize a variety of modes, a MAPC coordinator logic may be utilized to analyze telemetry and/or historical data to determine which mode of operation may be most suited to each AP grouping or pairing. Once determined, the MAPC coordinator may direct the APs to apply various parameters associated with each determined mode. Furthermore, various dynamic bandwidth switching may occur that can increase the data transmission throughput in response to determined congestion periods. These modes can also be directed dynamically by the MAPC coordinator on a per-grouping or per-pairing basis.

### CROSS-REFERENCE TO RELATED APPLICATION

This application claims the benefit of U.S. Provisional Patent Application No. 63/614,902, filed Dec. 26, 2023, which is incorporated by reference herein in its entirety.

The present disclosure relates to wireless networking. More particularly, the present disclosure relates to dynamically aligning wireless network capacity to fluctuating user demand.

### BACKGROUND

Wi-Fi, or wireless fidelity, is of paramount importance in the modern era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

Specifically, customers who are digitizing their critical business processes have the urgency of having their systems running without any interruption. For industries this means AGV's, Robots, Real Time machine data, Connected Workers with AR/VR, and for healthcare it means remote surgery, patient monitoring and many other business critical applications that need to operate without disruption.

Enterprise Wi-Fi networks often suffer from extreme congestion, stalled connections, and degraded performance during periods of high traffic load such as conferences, meetings, and other scheduled events. Dedicated Access Points (APs) become overwhelmed by the surge of bandwidth-hungry clients, leading to excessive lag, packet loss, and an inability to support critical applications. However, outside of these predictable higher-usage periods, the same APs remain drastically underutilized despite having unused airtime and capacity to handle additional clients and traffic. This results in highly inefficient wireless resource allocation, with intervals of severe congestion alternating with idle excess capacity. While enterprise Wi-Fi solutions can provide visibility into changing network usage, they lack intelligent coordination mechanisms to dynamically align Wi-Fi capacity to fluctuating user demand.

### SUMMARY OF THE DISCLOSURE

Systems and methods for dynamically aligning wireless network capacity to fluctuating user demand in accordance with embodiments of the disclosure are described herein.

In some embodiments, at least one network interface controller is configured to provide access to a network, and a memory communicatively coupled to the processor, wherein the memory includes a network management logic that is configured to determine an upcoming congestion period, generate one or more multi-access point coordination (MAPC) groupings, select a MAPC mode for each of the one or more MAPC groupings, and transmit at least one signal associated with the upcoming congestion period to the one or more MAPC groupings.

In some embodiments, the at least one signal is associated with the one or more MAPC groupings.

In some embodiments, the at least one signal is associated with a selected MAPC mode.

In some embodiments, the network management logic is further configured to evaluate telemetry data.

In some embodiments, the determination of the upcoming congestion period is based on the telemetry data.

In some embodiments, the network management logic is further configured to activate a dynamic bandwidth switching mode within a MAPC grouping.

In some embodiments, the network management logic is further configured to transmit data utilizing the dynamic bandwidth switching mode.

In some embodiments, the network management logic is further configured to receive feedback data.

In some embodiments, the feedback data is received from one or more MPAC groupings.

In some embodiments, the network management logic is further configured to adjust one or more parameters associated with the one or more MAPC groupings.

In some embodiments, the one or more parameters are adjusted based on the feedback data.

In some embodiments, at least one network interface controller is configured to provide access to a network, and a memory communicatively coupled to the processor, wherein the memory includes a network management logic that is configured to receive configuration data, configure into a multi-access point coordination (MAPC) pair based on the configuration data, apply a MAPC mode based on the configuration data, receive a pre-allocation request, and transmit a confirmation signal in response to the pre-allocation request.

In some embodiments, the pre-allocation request is associated with a plurality of dynamic bandwidth transmission opportunities.

In some embodiments, the network management logic is further configured to commit a transfer of data utilizing a dynamic bandwidth transmission mode.

In some embodiments, the transfer of data is configured to occur during the plurality of dynamic bandwidth transmission opportunities.

In some embodiments, the confirmation signal is transmitted to a plurality of network devices.

In some embodiments, the confirmation signal is transmitted to a MAPC coordinator.

In some embodiments, managing a network includes forecasting an upcoming congestion period, selecting a dynamic bandwidth transmission mode, selecting a plurality of dynamic bandwidth transmission opportunities, transmitting a schedule to an access point (AP) to pre-allocate the plurality of dynamic bandwidth transmission opportunities, receiving a confirmation from the AP associated with the schedule, and transmit data utilizing the selected dynamic bandwidth transmission mode.

In some embodiments, managing the network includes receiving feedback data.

In some embodiments, managing the network includes adjusting one or more parameters based on the feedback data.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a schematic block diagram of a call flow in a power management system, in accordance with various embodiments of the disclosure;

FIG. 3 is a conceptual network diagram of various environments that a network management logic may operate on a plurality of network devices, in accordance with various embodiments of the disclosure; and

FIG. 4 is a conceptual illustration of an artificial neural network, in accordance with various embodiments of the disclosure;

FIG. 5 is a flowchart depicting a process for applying unique multi-access point coordination modes in accordance with various embodiments of the disclosure;

FIG. 6 is a flowchart depicting a process for applying dynamic bandwidth switching modes to multi-access point coordination groups in accordance with various embodiments of the disclosure;

FIG. 7 is a flowchart depicting a process for committing dynamic bandwidth transmissions in accordance with various embodiments of the disclosure;

FIG. 8 is a flowchart depicting a process for managing an access point in a multi-access point coordination grouping utilizing dynamic bandwidth transmissions in accordance with various embodiments of the disclosure; and

FIG. 9 is a conceptual block diagram of a device suitable for configuration with a network management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

While enterprise Wi-Fi solutions can provide visibility into changing network usage, they typically lack intelligent coordination mechanisms to dynamically align Wi-Fi capacity to fluctuating user demand. Embodiments described herein describe innovative embodiments to optimize enterprise Wi-Fi performance using Multi-AP Coordination (MAPC), mode selections combined with Real-Time Dynamic Bandwidth Switching to expand capacity when predicting usage surges. Embodiments described herein include a MAPC mode selection and coordination, and Real-Time Dynamic Bandwidth Switching (RT-DBS) activation based on predictive bandwidth requirements. Intelligent coordination mechanisms are described in various embodiments herein to dynamically align Wi-Fi capacity to fluctuating user demand. Certain embodiments can utilize an innovative system to optimize enterprise Wi-Fi performance using Multi-AP Coordination, mode selection combined with RT-DBS to expand capacity when predicting usage surges.

In many embodiments, various systems, methods, and modules can be utilized. In certain embodiments, this can include traffic forecasting based on various data. The system can ingest real-time data such as scheduled conferences, meetings, location analytics, and historical network usage patterns. This data may then be fed into one or more machine learning models based on generalized linear regression to correlate past usage trends with meeting attributes like timing, location, room capacity, number of attendees, attendee devices, meeting type, etc. Periodic seasonal patterns can be modelled by having the model learn coefficients associated with day of week, month, and holiday effects. The trained model can then be used to predict future expected traffic volumes and congestion levels for each access point's (AP's) basic service set identification (BSSID) on a per-radio basis given information about scheduled events in those spaces covered by that AP. For a given AP BSSID at any point in the prediction horizon, the forecast can provide the expected number of clients that will be associated, the aggregate bandwidth demand across those clients, the distribution across traffic types (video, VoIP, HTTP etc.), and the expected congestion level (percentage of airtime utilization). These predictions can be performed independently for each radio supported by the AP.

In more embodiments, a multi-AP coordination optimization can be utilized. The forecasted traffic demands can be used to perform predictive optimization of Multi-AP Coordination (MAPC) configurations across APs to best match anticipated loads. Various embodiments described herein can utilize AP Groupings. The system can use graph-based spectral clustering between APs to divide them into coordination groups (CGs) suitable for spatial reuse given their RF neighborhood relationships. These CGs determine sets of APs that can concurrently transmit without excessive interference enabling spatial reuse.

Nowadays, the consumption of high-bandwidth and real time applications constitutes a massive challenge for operators and network companies to deliver these contents to end users. Beyond traditional video streaming consumption, cloud gaming, virtual and augmented reality (VR/AR) are rapidly becoming more and more popular, hence further contributing to and increasing the demand of interactive and delay-sensitive contents.

To address this, Wi-Fi networks are constantly evolving to handle the high requirements of these applications in terms of throughput and/or latency, but also the increasing number of users and the traffic volume on the Internet. Access Point (AP) densification (i.e., covering the same area with a high number of APs) has been the natural response to cope with such situations. This approach allows stations to benefit from high Signal-to-Noise (SNR) levels, as they are close to their serving APs, resulting in the use of high-transmission rates. However, when the number of co-located APs is high, the limited number of frequency channels may result in detrimental high contention and interference levels, as well as affecting the ability of the Wi-Fi networks to provide a reliable service. A solution to mitigate the high contention levels in dense Wi-Fi deployments is to coordinate transmissions from the set of overlapping APs.

To support such an objective, the Multi-Access Point Coordination (MAPC) framework was initially included as part upcoming Wi-Fi standards. MAPC allows APs to share time, frequency and/or spatial resources in a controlled manner, alleviating Overlapping Basic Service Set (OBSS) contention, and enabling the implementation of WLAN-level scheduling mechanisms. MAPC aims to improve the overall network performance by allowing Access Points (APs) to share time, frequency and/or spatial resources in a coordinated way, thus alleviating inter-AP contention and enabling new multi-AP channel access strategies.

In wireless networking, a TXOP, or Transmission Opportunity, refers to a time interval during which a wireless station or device has the exclusive right to transmit data over the wireless medium. It is a concept associated with the IEEE 802.11 standard, commonly known as Wi-Fi. The TXOP mechanism is designed to improve network efficiency and reduce contention by allocating specific time slots for data transmission. It helps in managing the shared communication medium by preventing multiple stations from attempting to transmit simultaneously, thereby reducing collisions, and enhancing overall network performance. The TXOP is part of the medium access control (MAC) layer in the IEEE 802.11 standard and plays a crucial role in optimizing the utilization of the available wireless bandwidth.

Various embodiments can utilize MAPC Mode Selections. These MAPC modes can include a plurality of types that can be assigned to different coordination groupings. Frequency Division Multiple Access (FDMA) is a type of channelization protocol. In this setup, bandwidth is divided into various frequency bands. Each network device is allocated with a band to send data and that band is reserved for that particular network device for a specified time. The frequency bands of different network devices are separated by a small band of unused frequency and that unused frequency bands are often referred to as guard bands that can prevent the interference of other network devices.

Time Division Multiple Access (TDMA) is a channelization protocol in which the bandwidth of a channel is divided into various network devices on a time basis. There is a time slot given to each network device, which can transmit data during that time slot only. Each network device should be aware of its time slot beginning and the location of the time slot. TDMA often requires synchronization between the different network devices.

In Code Division Multiple Access (CDMA), all of the network devices can transmit data simultaneously. It allows each network device to transmit data over the entire frequency all the time. Multiple simultaneous transmissions are separated by a unique code sequence, wherein each user is assigned with a unique code sequence.

For each coordination group, the optimal MAPC mode (TDMA, C-FDMA, C-Spatial Reuse, etc.) to use during the predicted high congestion period can be selected by evaluating the expected traffic classifications and congestion levels against a decision tree model trained on data from simulations. In certain embodiments, a decision tree model can predict the highest performing MAPC mode given the characteristics of the traffic predicted by the forecasting module. It may use rules evaluating factors like number of clients, end devices capabilities, expected congestion levels, prevalent traffic types (burst/streaming), impact of congestion on QoS requirements, and/or the number of high-bandwidth clients.

In particular, C-FDMA may be used to dynamically change the bandwidth of the channel in accordance with the neighboring channel allocation/spacing established by RRM. For example, the AP about the cubicle may be loaded while employees are at their desk but relatively idle as these same employees move to a new room that is on the different or even co-channel with the cubicle AP. This shift in demand can be met by reducing the cubicle AP's channel width while simultaneously increasing the meeting rooms channel wide (i.e., with C-FDMA).

Additional embodiments can utilize predictive RT-DBS activation. The expected traffic volume time series data is evaluated by the system to determine periods of exceptionally high bandwidth demand where using RT-DBS would be beneficial. For the APs forecasted to encounter heavy congestion due to many high-bandwidth clients based on the predictive optimization, the system proactively triggers targeted activation of RT-DBS for that AP during that high demand period.

RT-DBS can allow the AP to temporarily increase its bandwidth to e.g. 160/320 MHz to support very high throughput. Shorter 20-40 ms RT-DBS transmissions are staggered between CGs and interlaced with regular TXOPs to avoid interference, the MAPC controller (I.e., C-FDMA) coordinates the RT-DBS activation across APs using the following control channel handshake between the controller and APs: MAPC to AP (Pre-allocate RT-DBS TXOP), AP to device (Confirm new BWs for a number “n” of upcoming TXOPs), AP to MAPC (Confirm proposed RT-DBS TXOP schedule), and MAPC to AP (Commit RT-DBS TXOP).

In further embodiments, closed loop optimization can be utilized. As the system runs, real-time metrics can be collected on usage, throughput, latency and congestion from the APs and clients. This real-time feedback data can be fed into a Q-learning based reinforcement learning controller that continuously tunes parameters (KPIs related to network efficiency, congestion and QoS).

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

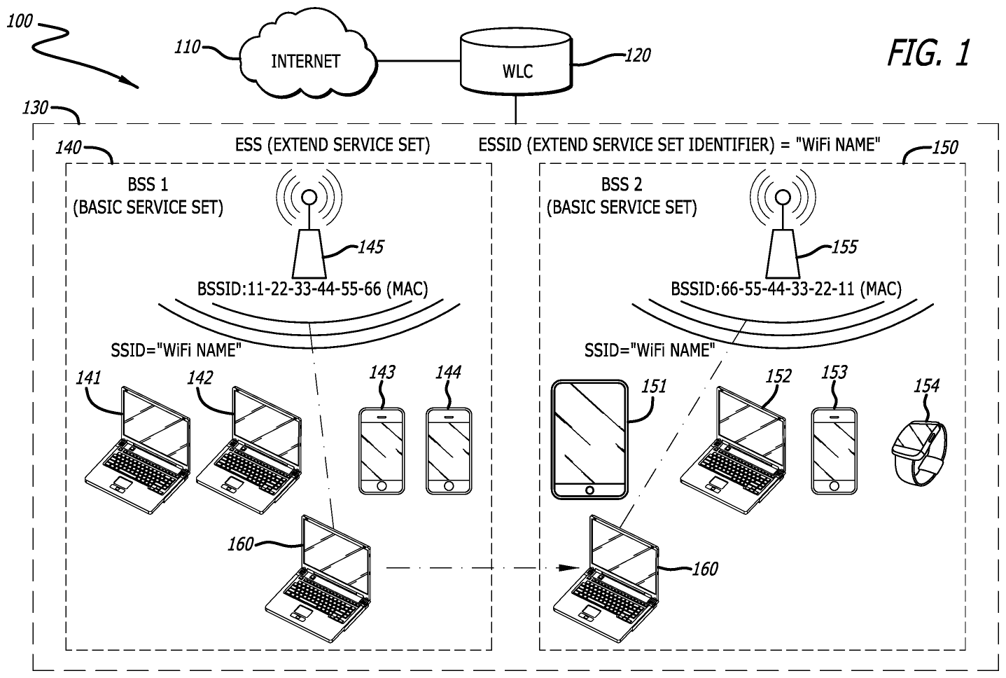

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11 g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

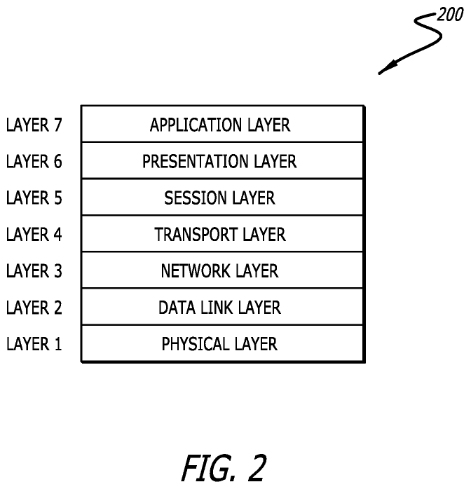

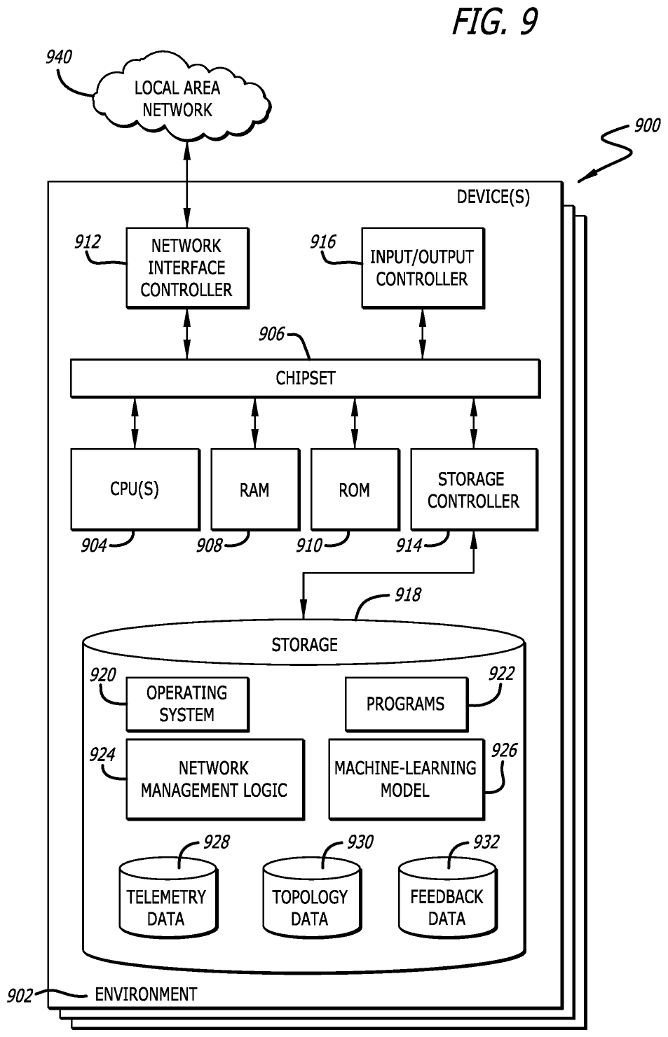

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 9, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “WiFi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-9 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer, can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer, can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-9 as required to realize a particularly desired embodiment.

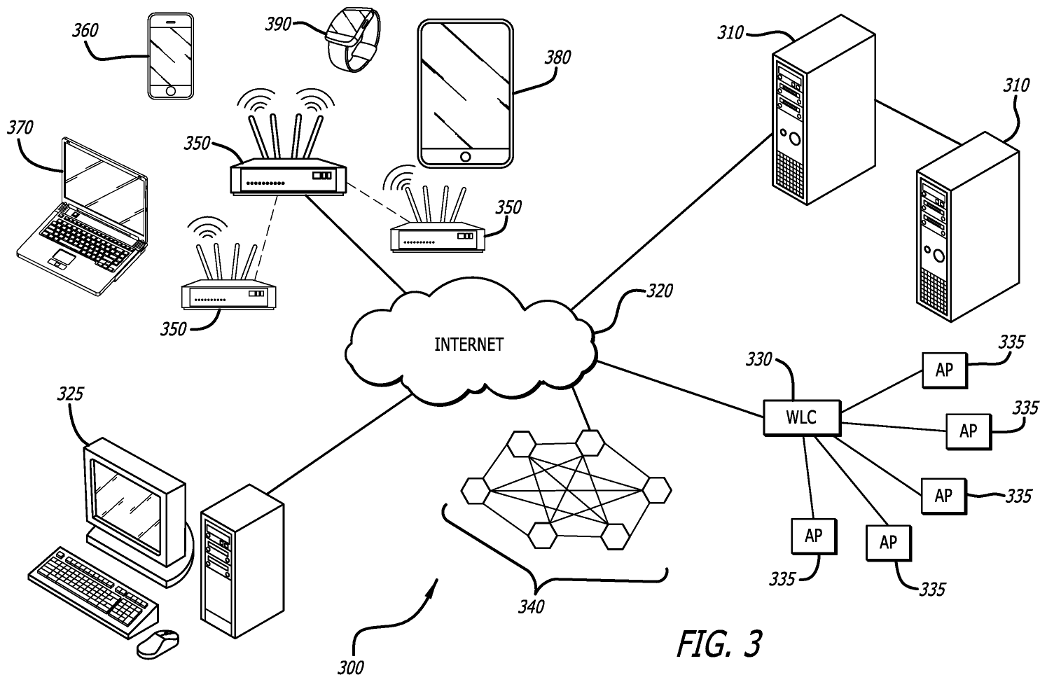

Referring to FIG. 3, a conceptual network diagram 300 of various environments that a network management logic may operate on a plurality of network devices, in accordance with various embodiments of the disclosure is shown. Those skilled in the art will recognize that the network management logic can include various hardware and/or software deployments and can be configured in a variety of ways. In many embodiments, the network management logic can be configured as a standalone device, exist as a logic in another network device, be distributed among various network devices operating in tandem, or remotely operated as part of a cloud-based network management tool. In further embodiments, one or more servers 310 can be configured with the network management logic or can otherwise operate as the networking logic. In many embodiments, the network management logic may operate on one or more servers 310 connected to a communication network 320 (shown as the “Internet”). The communication network 320 can include wired networks or wireless networks. The network management logic can be provided as a cloud-based service that can service remote networks, such as, but not limited to a deployed network 340.

However, in additional embodiments, the network management logic may be operated as a distributed logic across multiple network devices. In the embodiment depicted in FIG. 3, a plurality of network access points (APs) 350 can operate as the network management logic in a distributed manner or may have one specific device operate as the network management logic for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the network management logic may be integrated within another network device. In the embodiment depicted in FIG. 3, a wireless LAN controller (WLC) 330 may have an integrated network management logic that the WLC 330 can use to monitor or control power consumption of the APs 335 that the WLC 330 is connected to, either wired or wirelessly. In still more embodiments, a personal computer 325 may be utilized to access and/or manage various aspects of the networking logic, either remotely or within the network itself. In the embodiment depicted in FIG. 3, the personal computer 325 communicates over the communication network 320 and can access the network management logic of the servers 310, or the network APs 350, or the WLC 330. In many embodiments, the WLC 330 may be configured as a MAPC coordinator.

Although a specific embodiment for various environments that the network management logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the network management logic may be provided as a device or software separate from the WLC 330 or the network management logic may be integrated into the WLC 330. The elements depicted in FIG. 3 may also be interchangeable with other elements of FIGS. 1-2 and FIGS. 4-9 as required to realize a particularly desired embodiment.

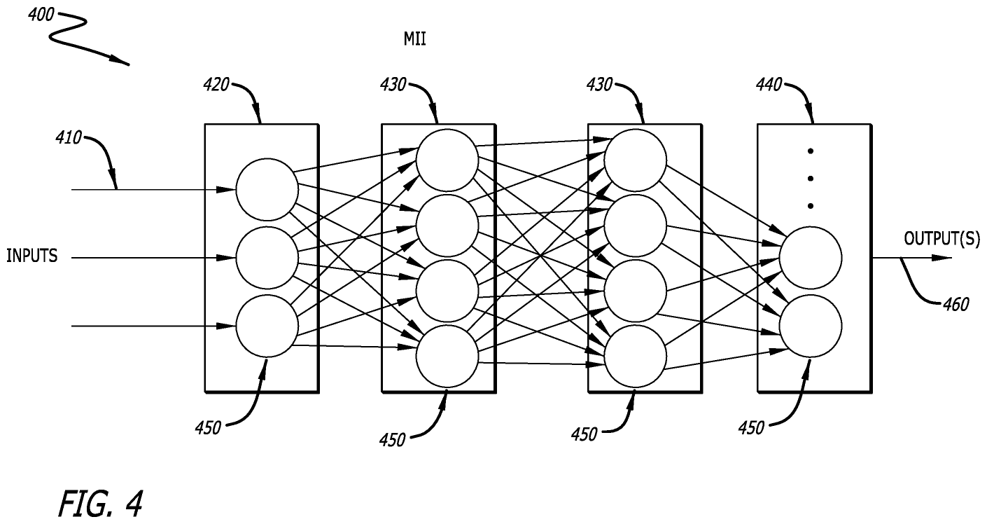

Referring to FIG. 4, a conceptual illustration of an artificial neural network 400, in accordance with various embodiments of the disclosure is shown. As those skilled in the art will recognize, various methods of machine learning models can be utilized to achieve desired outcomes efficiently. For example, some embodiments may utilize decisions trees, random forests, support vector machines, naïve Bayes, or K-nearest neighbors algorithms. However, artificial neural networks have increased in popularity, especially in deep learning techniques where detection of complex patterns in data and the ability to solve a wide range of problems has been desired. In various embodiments, an artificial neural network may be utilized. Artificial neural networks are a type of machine learning model inspired by the structure and function of the human brain, and often consist of three main types of layers: the input layer, the output layer, and one or more intermediate (also called hidden) layers.

In many embodiments, the input layer is responsible for receiving input data, which could be anything from an image to a text document to numerical values. Each input feature can be represented by a node in the input layer. Conversely, the output layer is often responsible for producing the output of the network, which could be, for example, a prediction or a classification. The number of nodes in the output layer can depend on the task at hand. For example, if the task is to classify images into ten different categories, there would be ten nodes in the output layer, each representing a different category.

In a number of embodiments, the intermediate layers are where the specialized connections are made. These intermediate layers are responsible for transforming the input data in a non-linear way to extract meaningful features that can be used for the final output. In various embodiments, a node in an intermediate layer can take as an input a weighted sum of the outputs from the previous layer, apply a non-linear activation function to it, and pass the result on to the next layer. The weights of the connections between nodes in the layers are learned during training. This training can utilize backpropagation, which may involve calculating the gradient of the error with respect to the weights and adjusting the weights accordingly to minimize the error.

In various embodiments, at a high level, the artificial neural network 400 depicted in the embodiment of FIG. 4 includes a number of inputs 410, an input layer 420, one or more intermediate layers 430, and an output layer 440. The artificial neural network 400 may comprise a collection of connected units or nodes called artificial neurons 450, which loosely model the neurons in a biological brain. Each connection, like the synapses in a biological brain, can transmit a signal from one artificial neuron to another. An artificial neuron that receives a signal can process the signal and then trigger additional artificial neurons within the next layer of the neural network. As those skilled in the art will recognize, the artificial neural network 400 depicted in FIG. 4 is shown as an illustrative example, and various embodiments may comprise artificial neural networks that can accept more than one type of input and can provide more than one type of output.

In additional embodiments, the signal at a connection between artificial neurons is a value, and the output of each artificial neuron is computed by some nonlinear function (called an activation function) of the sum of the artificial neuron's inputs. Often, the connections between artificial neurons are called “edges” or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals propagate from the first layer (the input layer 420) to the last layer (the output layer 440), possibly after traversing one or more intermediate layers (also called hidden layers) 430.

In further embodiments, the inputs to an artificial neural network may vary depending on the problem being addressed. In object detection for example, the inputs may be data representing values for certain corresponding actual measurements or values within the object to be detected. In one embodiment, the artificial neural network 400 comprises a series of hidden layers in which each neuron is fully connected to neurons of the next layer. The artificial neural network 400 may utilize an activation function such as sigmoid, nonlinear, or a rectified linear unit (ReLU), upon the sum of the weighted inputs, for example. The last layer in the artificial neural network may implement a regression function to produce the classified or predicted classifications output for object detection as output 460. In further embodiments, a sigmoid function can be used, and the prediction may need raw output transformation into linear and/or nonlinear data.

Although a specific embodiment for an artificial neural network machine learning model suitable for carrying out the various steps, processes, methods, and operations described herein is discussed with respect to FIG. 4, any of a variety of systems and/or processes may be utilized in accordance with embodiments of the disclosure. For example, the artificial neural network may be external operated, such as through a cloud-based service, or a third-party service. The elements depicted in FIG. 4 may also be interchangeable with other elements of FIGS. 1-3 and FIGS. 5-9 as required to realize a particularly desired embodiment.

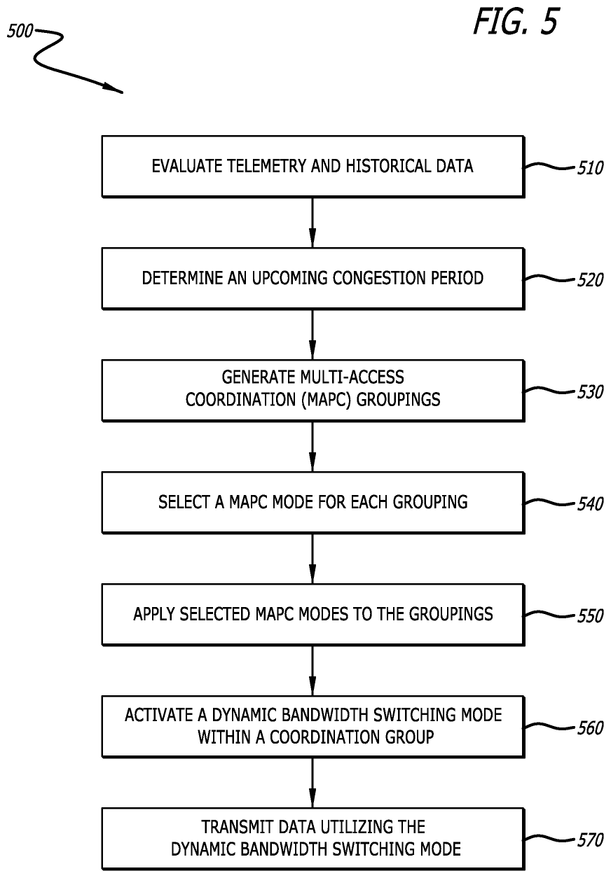

Referring to FIG. 5, a flowchart depicting a process 500 for applying unique multi-access point coordination modes in accordance with various embodiments of the disclosure is shown. In many embodiments, the process 500 can evaluate telemetry and historical data (block 510). Telemetry data, which may include real-time information on network parameters such as signal strength, bandwidth usage, and latency, among others, can provide immediate insights into the current state of the network. Historical data, on the other hand, can offer a broader perspective by capturing trends and patterns over time. Evaluating historical data may help predict usage patterns, and allow for planning of capacity expansion. In certain embodiments, the use of advanced analytics tools and machine learning algorithms can further refine the evaluation process, providing more accurate predictions and actionable insights for efficient wireless network management.

In a number of embodiments, the process 500 can determine an upcoming congestion period (block 520). Detecting an upcoming congestion period in wireless networking can involve analyzing various parameters and patterns within the network. One crucial indicator is monitoring the data traffic and usage patterns over time. Sudden increases in data demand or consistently high usage during specific hours may signify an impending congestion period. Telemetry data, such as signal strength, packet loss, and latency, can also be valuable in identifying potential congestion points. Anomalies or degradations in these metrics might indicate network stress. Additionally, historical data analysis helps in recognizing recurring congestion patterns based on past incidents, enabling proactive measures. Continuous monitoring of device connectivity and user density in specific areas can also contribute to congestion prediction. Implementing intelligent traffic forecasting algorithms and machine learning models that consider these factors aids in more accurate predictions of congestion periods, allowing network administrators to take preemptive actions, such as load balancing, channel optimization, or capacity expansion, to ensure a smooth and uninterrupted wireless network experience.

In more embodiments, the process 500 can generate multi-access point coordination (MAPC) groupings (block 530). Generating MAPC groupings can involve several key considerations and strategies. First, a careful channel assignment may be considered, distributing access points across non-overlapping channels to minimize interference. Channel coordination mechanisms, such as Dynamic Frequency Selection (DFS) and Transmit Power Control (TPC), can help adapt channel usage dynamically based on environmental conditions. In some embodiments, logical groupings can be formed by configuring access points with the same Service Set Identifier (SSID), facilitating seamless client roaming. Identification and mitigation of interference sources, along with centralized management systems, may further enhance the coordination of multiple access points. Dynamic reconfiguration mechanisms can adapt to changes in the network environment, ensuring flexibility. Additionally, traffic engineering policies and consistent security configurations across the coordination group can contribute to a well-optimized and secure wireless network. The specific implementation may vary based on the wireless networking equipment, protocols, and technologies used in a particular environment.

In additional embodiments, the process 500 can select a MAPC mode for each grouping (block 540). As discussed above, a MAPC configuration can utilize various modes of operation. This may include TDFA, C-TDMA, FDMA, C-FDMA, C-Spatial Reuse and the like. Each of these modes can have different pros and cons, and may be optimal in different situations. Based on this, each MAPC grouping can be evaluated and have a mode selected that would best match the current conditions to increase network optimization.

In further embodiments, the process 500 can apply the selected MAPC mode to the groupings (block 550). In response to having a MAPC mode selected, the process 500 can generate and transfer those settings to each MAPC grouping. In some embodiments, the network devices associated with the MAPC groupings can respond with a confirmation signal that the MAPC mode was applied successfully.

In still more embodiments, the process 500 can activate a dynamic bandwidth switching mode within a coordination group (block 560). In certain embodiments, the mode can be a real-time dynamic bandwidth switching (RT-DBS) mode. Activating Dynamic Bandwidth Switching (DBS) in wireless networking can involve several key steps to dynamically adjust the channel or bandwidth based on network conditions. The first step is to ensure that the hardware, including both the wireless access points and client devices, supports DBS. Configuration settings for dynamic bandwidth switching can typically be found in the management interface of the access points, where options such as channel width (20 MHz, 40 MHz, 80 MHz, or 160 MHz) may be available. Consideration of environmental factors, such as potential interference sources, may also occur.

In various embodiments, the process 500 can transmit data utilizing the dynamic bandwidth switching mode bandwidth (block 570). Once activated, the network devices, such as the MAPC grouping can transmit data utilizing that dynamic bandwidth switching mode. This can occur during a plurality of transmission opportunities that were pre-allocated and/or pre-scheduled. As those skilled in the art will recognize, this can occur for a variable period of time based on various factors such as the amount of data that needs to be transferred, the current network conditions, potential interference, etc.

Although a specific embodiment for a process for applying unique multi-access point coordination modes suitable for carrying out the various steps, processes, methods, and operations described herein is discussed with respect to FIG. 5, any of a variety of systems and/or processes may be utilized in accordance with embodiments of the disclosure. For example, the groupings can be coordination pairs, as described in more detail below. The elements depicted in FIG. 5 may also be interchangeable with other elements of FIGS. 1-4 and FIGS. 6-9 as required to realize a particularly desired embodiment.

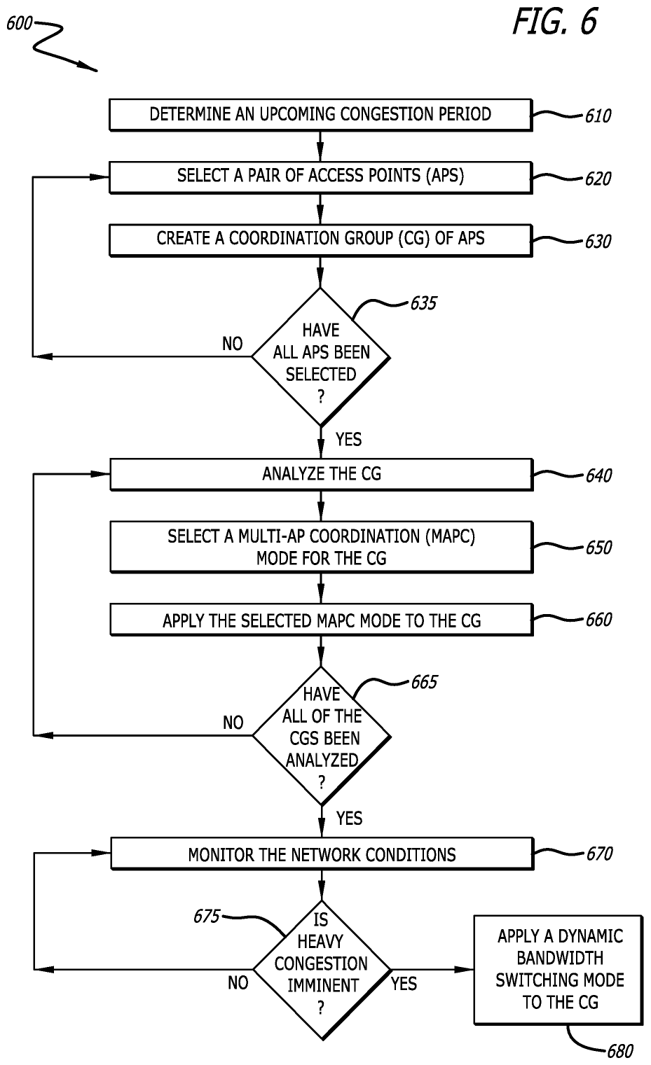

Referring to FIG. 6, a flowchart depicting a process 600 for applying dynamic bandwidth switching modes to multi-access point coordination groups in accordance with various embodiments of the disclosure is shown. In many embodiments, the process 600 can determine an upcoming congestion period (block 610). As mentioned in the process described in FIG. 5, determining an upcoming congestion period can be accomplished by examining current telemetry data, and/or historical data. Based on this, events such as determined user client device movements, etc. can be utilized to predict future network issues.

In a number of embodiments, the process 600 can select a pair of access points (block 620). When managing a local wireless network, various APs can be configured as pairs to operate in coordination. In some embodiments, this can be done as multi-access point coordination groupings. In more embodiments, the process 600 can create a coordination group of APs (block 630). This can be done by, in certain embodiments, a MAPC coordinator sending one or more signals to the various APs can include various parameters associated with and directing the APs to enter the coordination group.

In additional embodiments, the process 600 can determine if all APs have been selected (block 635). If it is determined that all APs have not been selected, the process 600 can again select a pair of APs (block 620). However, if it is determined that the process 600 has selected and grouped all available APs, the process 600 can further analyze a coordination group (block 640). This analysis can include evaluating the current network conditions associated with the coordination group.

In further embodiments, the process 600 can select a multi-AP coordination (MAPC) mode for the coordination group (block 650). As described above, a MAPC configuration can utilize various modes of operation. This may include TDFA, C-TDMA, FDMA, C-FDMA, C-Spatial Reuse and the like. Each of these modes can have different pros and cons, and may be optimal in different situations. Based on this, each MAPC grouping can be evaluated and have a mode selected that would best match the current conditions to increase network optimization.

In still more embodiments, the process 600 can apply the selected MAPC mode to the coordination group (block 660). In response to having a MAPC mode selected, the process 600 can generate and transfer those settings to each MAPC grouping. In some embodiments, the network devices associated with the MAPC groupings can respond with a confirmation signal that the MAPC mode was applied successfully.

In various embodiments, the process 600 can determine if all of the coordination groups have been analyzed (block 665). If it is determined that not all of the coordination groups have been analyzed, the process 600 can again analyze a coordination group (block 640). However, if it is determined that all of the coordination groups have been analyzed, the process 600 can monitor the network conditions (block 670). This monitoring can be related to the current telemetry, or may include analyzing the current telemetry in relation to historical data.

In numerous embodiments, the process 600 can determine if heavy congestion is imminent (block 675). If it is determined that heavy congestion is not imminent, the process 600 can continue to monitor the network conditions (block 670). However, when it is determined that a period of heavy congestion is coming, the process 600 can apply a dynamic bandwidth switching mode to the coordination group (block 680). As discussed above, the dynamic bandwidth switching mode can be applied during period of high congestion to transmit more data utilizing increased bandwidth frequencies, etc.

Although a specific embodiment for a process for applying dynamic bandwidth switching modes to multi-access point coordination groups suitable for carrying out the various steps, processes, methods, and operations described herein is discussed with respect to FIG. 6, any of a variety of systems and/or processes may be utilized in accordance with embodiments of the disclosure. For example, the coordination groupings can be re-evaluated and re-assigned based on various events, such as, but not limited to, a change in network congestions, a change in network device statuses, a change in client devices or applications, etc. The elements depicted in FIG. 6 may also be interchangeable with other elements of FIGS. 1-5 and FIGS. 7-9 as required to realize a particularly desired embodiment.

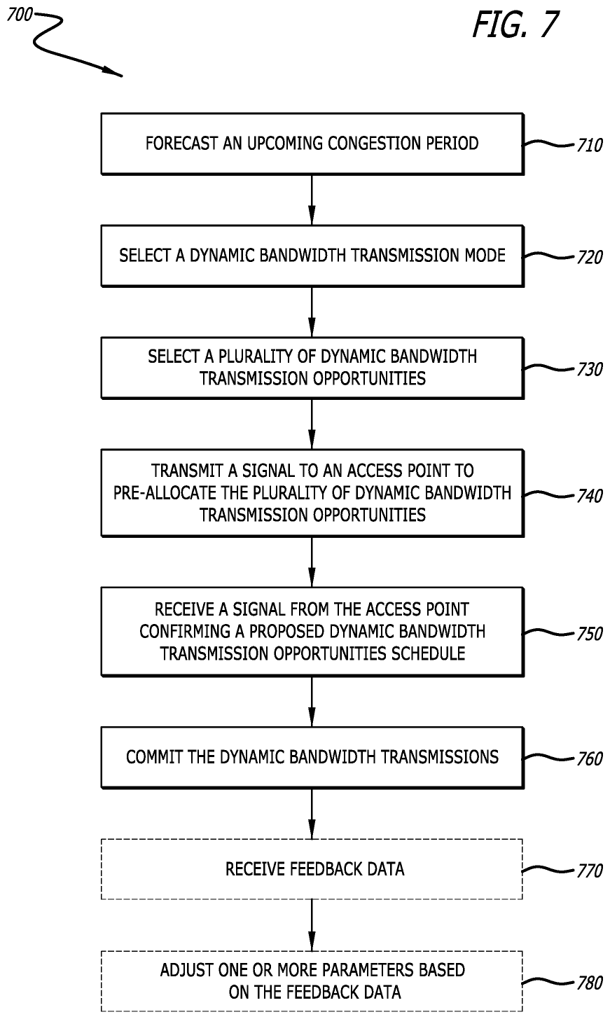

Referring to FIG. 7, a flowchart depicting a process for committing dynamic bandwidth transmissions in accordance with various embodiments of the disclosure is shown. In many embodiments, the process 700 can forecast an upcoming congestion period (block 710). As mentioned in the process described in FIG. 5, forecasting an upcoming congestion period can be accomplished by examining current telemetry data, and/or historical data. Based on this, events such as determined user client device movements, etc. can be utilized to predict future network issues.

In a number of embodiments, the process 700 can select a dynamic bandwidth transmission mode (block 720). As discussed above, a MAPC configuration can utilize various modes of operation. This may include TDFA, C-TDMA, FDMA, C-FDMA, C-Spatial Reuse and the like. Each of these modes can have different pros and cons, and may be optimal in different situations. Based on this, each MAPC grouping can be evaluated and have a mode selected that would best match the current conditions to increase network optimization.

In more embodiments, the process 700 can select a plurality of dynamic bandwidth transmission opportunities (block 730). A wireless network can determine transmission opportunities through the utilization of various protocols such as, but not limited to, Carrier Sense Multiple Access with Collision Avoidance (CSMA/CA). These protocols can commonly be used in wireless communications to manage access to a shared communication medium, such as the airwaves. Before initiating a transmission, a device can listen to a channel to check for ongoing transmissions. If the channel is sensed as idle, the device assumes that it has a transmission opportunity and proceeds to transmit its data. However, if the channel is busy, the device can defer its transmission to avoid collisions. To further enhance collision avoidance, devices may employ additional techniques, such as “Request to Send/Clear to Send” (RTS/CTS). In these embodiments, a transmitting device can send a Request to Send frame, and if the receiving device is ready to accept the transmission, it responds with a Clear to Send frame, reserving the channel for the upcoming data transfer. However, as those skilled in the art will recognize, the use of additional methods can be made to schedule a plurality of transmission opportunities in the future.

In additional embodiments, the process 700 can transmit a signal to an access point to pre-allocate the plurality of dynamic bandwidth transmission opportunities (block 740). The signal can be a schedule for the plurality of the upcoming dynamic bandwidth transmission opportunities. In certain embodiments, the signal can be transmitted to specific APs, but in further embodiments, the signal can be transmitted to multiple APs that are associated with the schedule. In still further embodiments, the process 700 can receive a signal from the access point confirming a proposed dynamic bandwidth transmission opportunities schedule (block 750). This confirmation can be optional, but may be received prior to initiating transmission at the dynamic bandwidth switching mode.

In still more embodiments, the process 700 can commit the dynamic bandwidth transmissions (block 760). Once activated, the network devices, such as a MAPC grouping can transmit data utilizing that dynamic bandwidth switching mode. This can occur during a plurality of transmission opportunities that were pre-allocated and/or pre-scheduled. As those skilled in the art will recognize, this can occur for a variable period of time based on various factors such as the amount of data that needs to be transferred, the current network conditions, potential interference, etc.

In certain optional embodiments, the process 700 can receive feedback data (block 770). During the transmission of data, feedback data can be generated, which can be received from one or more APs. The feedback data can be configured to indicate various aspects of the transmissions. This can include the current congestion, efficiency, settings, and other telemetry, etc. In further optional embodiments, the process 700 can adjust one or more parameters based on the feedback data (block 780). This can be done dynamically done during the entire transmission process. However, it may be done in response to an event or after elapsing of a period of time or transmissions.

Although a specific embodiment for a process for committing dynamic bandwidth transmissions suitable for carrying out the various steps, processes, methods, and operations described herein is discussed with respect to FIG. 7, any of a variety of systems and/or processes may be utilized in accordance with embodiments of the disclosure. For example, the feedback data can be received from the APs, but may be gathered in certain embodiments by a MAPC controller or similar network device and/or logic. The elements depicted in FIG. 7 may also be interchangeable with other elements of FIGS. 1-6 and FIGS. 8-9 as required to realize a particularly desired embodiment.

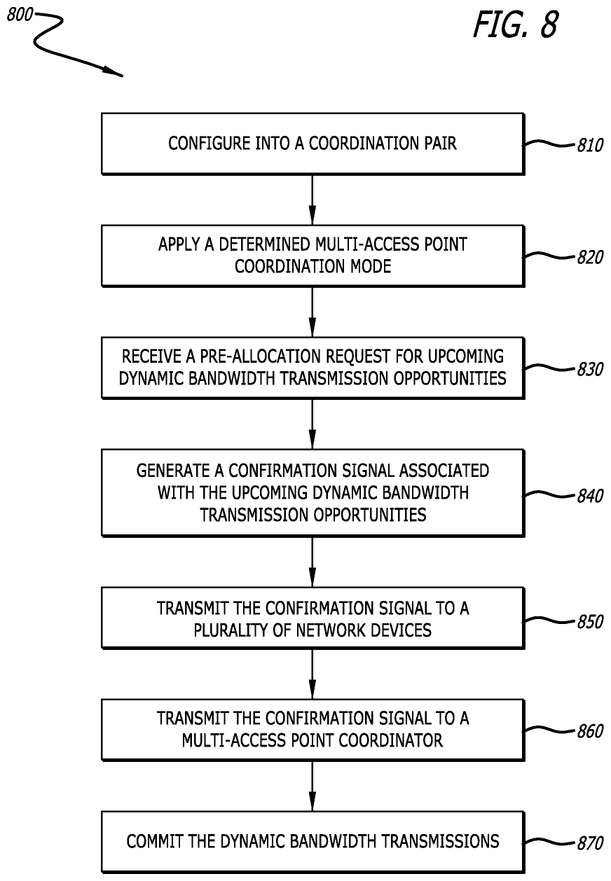

Referring to FIG. 8, a flowchart depicting a process for managing an access point in a multi-access point coordination grouping utilizing dynamic bandwidth transmissions in accordance with various embodiments of the disclosure. In many embodiments, the process 800 can configure into a coordination pair (block 810). This can be done by, in certain embodiments, a MAPC coordinator sending one or more signals to the various APs can include various parameters associated with and directing the APs to enter the coordination pair/group.

In a number of embodiments, the process 800 can apply a determined multi-access point coordination mode (block 820). Again, as discussed above, a MAPC configuration can utilize various modes of operation. This may include TDFA, C-TDMA, FDMA, C-FDMA, C-Spatial Reuse and the like. Each of these modes can have different pros and cons, and may be optimal in different situations. Based on this, each MAPC grouping can be evaluated and have a mode selected that would best match the current conditions to increase network optimization. In some embodiments, the MAPC coordinator may send the determined mode which can be received and applied.

In more embodiments, the process 800 can receive a pre-allocation request for upcoming dynamic bandwidth transmission opportunities (block 830). This can be in the form of a schedule determined by a MAPC coordinator. In additional embodiments, the transmission opportunities can be based on a corresponding event or in response to a future trigger. In additional embodiments, the process 800 can generate a confirmation signal associated with the upcoming dynamic bandwidth transmission opportunities (block 840). This confirmation signal can be an agreement that the proposed schedule will be followed.

In further embodiments, the process 800 can generate a confirmation signal to a plurality of network devices (block 850). In certain embodiments, the process 800 may be working in tandem with other network devices, such as with APs who are in coordination pairs or groupings. In these embodiments, the process 800 can notify the other associated network devices of the schedule and/or the agreement to the proposed transmission opportunity schedule.

In still more embodiments, the process 800 can transmit the confirmation signal to a multi-access point coordinator (block 860). This confirmation signal can be added to one or more frames of data sent back and forth between an AP and a MAPC coordinator. However, in some embodiments, a confirmation signal may not be necessary as the MAPC coordinator can assume that the schedule will be followed unless otherwise prompted.

In various embodiments, the process 800 can commit the dynamic bandwidth transmission (block 870). Once approved, the network devices, such as a MAPC pairing or grouping of APs can transmit data utilizing the proposed schedule. In many embodiments, this schedule is association with a dynamic bandwidth switching mode. This can occur during a plurality of transmission opportunities that were pre-allocated and/or pre-scheduled. As those skilled in the art will recognize, this can occur for a variable period of time based on various factors such as the amount of data that needs to be transferred, the current network conditions, potential interference, etc.

Although a specific embodiment for a process for managing an access point in a multi-access point coordination grouping utilizing dynamic bandwidth transmissions suitable for carrying out the various steps, processes, methods, and operations described herein is discussed with respect to FIG. 8, any of a variety of systems and/or processes may be utilized in accordance with embodiments of the disclosure. For example, the process 600 may be operated within an AP, but may be conducted on other network devices in communication with an AP. The elements depicted in FIG. 8 may also be interchangeable with other elements of FIGS. 1-7 and FIG. 9 as required to realize a particularly desired embodiment.

Referring to FIG. 9, a conceptual block diagram of a device 900 suitable for configuration with a networking logic, in accordance with various embodiments of the disclosure is shown. The embodiment of the conceptual block diagram depicted in FIG. 9 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-3. In certain embodiments, the device 900 can also include computer-readable storage media having instructions stored thereupon for performing any of the other computer-implemented operations described herein.

In many further embodiments, the device 900 may include a network management logic 924. The network management logic 924 can be configured to perform one or more of the various steps, processes, operations, and/or other methods that are described above. Often, the network management logic 924 can be a set of instructions stored within a non-volatile memory that, when executed by the processor(s)/controller(s) 904 can carry out these steps, etc. In some embodiments, the network management logic 924 may be a client application that resides on a network-connected device, such as, but not limited to, a server, switch, personal or mobile computing device in a single or distributed arrangement.

In some embodiments, telemetry data 928 can encompass real-time measurements crucial for monitoring and optimizing network performance. It may include details like bandwidth usage, latency, packet loss, and error rates, providing insights into data transmission quality and identifying potential issues. Telemetry data 928 may also cover traffic patterns and application performance, supporting capacity planning and ensuring optimal user experience. The collection and analysis of this data are essential for proactive network management, facilitated by advanced monitoring tools and technologies. In further embodiments, the telemetry data 928 can include historical data related to past network activity.

In various embodiments, topology data 930 can comprise information detailing the physical or logical arrangement of network devices and their interconnections. This data can provide insights into the structure of the network, including the relationships between routers, switches, servers, and other components. Topology data 930 can describe the actual layout of devices, such as their placement in a building or across multiple locations, while logical topology data may focus on the communication paths and relationships between devices regardless of their physical location. Understanding network topology is crucial for troubleshooting, optimizing performance, and planning for scalability. It can enable network administrators to identify potential points of failure, ensure efficient data flow, and make informed decisions about network expansion or reconfiguration. Advanced tools and technologies are often employed to visualize and analyze topology data 930, aiding in the effective management and maintenance of complex network infrastructures.

In a number of embodiments, feedback data 932 may comprise detailed information about processes, individual devices, and/or applications connected to the network. This data can include, for example, unique identifiers known as MAC addresses assigned to each wireless device, indicating their presence on the network and any data associated with them such that parsing of the feedback data 932 is possible on a granular level. Feedback data 932 can encompass the current connection status of each device, indicating whether it is actively connected or not, and how any process is currently going. Additionally, it can provide insights into signal strength, offering information about the quality of the wireless connection as well as data usage metrics which can specify the amount of data transmitted and received by each device. In more embodiments, the feedback data 932 can include monitoring data crucial for network administrators or management logics to optimize network performance, troubleshoot connectivity issues, and manage resources effectively, providing a comprehensive view of the devices interacting within the wireless environment. Advanced network management tools can offer real-time insights into station data, empowering administrators to make informed decisions regarding network optimization and security.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the telemetry data 928, the power topology data 930, and the station data 932. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for a device suitable for configuration with the network management logic for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or APs. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network; and
a memory communicatively coupled to the processor, wherein the memory comprises a network management logic that is configured to:
determine an upcoming congestion period;
generate one or more multi-access point coordination (MAPC) groupings;
select a MAPC mode for each of the one or more MAPC groupings; and
transmit at least one signal associated with the upcoming congestion period to the one or more MAPC groupings.

2. The device of claim 1, wherein the at least one signal is associated with the one or more MAPC groupings.

3. The device of claim 1, wherein the at least one signal is associated with a selected MAPC mode.

4. The device of claim 1, wherein the network management logic is further configured to evaluate telemetry data.

5. The device of claim 4, wherein the determination of the upcoming congestion period is based on the telemetry data.

6. The device of claim 1, wherein the network management logic is further configured to activate a dynamic bandwidth switching mode within a MAPC grouping.

7. The device of claim 6, wherein the network management logic is further configured to transmit data utilizing the dynamic bandwidth switching mode.

8. The device of claim 7, wherein the network management logic is further configured to receive feedback data.

9. The device of claim 8, wherein the feedback data is received from one or more MPAC groupings.

10. The device of claim 8, wherein the network management logic is further configured to adjust one or more parameters associated with the one or more MAPC groupings.

11. The device of claim 10, wherein the one or more parameters are adjusted based on the feedback data.

12. A device, comprising:
a processor;
at least one network interface controller configured to provide access to a network; and
a memory communicatively coupled to the processor, wherein the memory comprises a network management logic that is configured to:
receive configuration data;
configure into a multi-access point coordination (MAPC) pair based on the configuration data;
apply a MAPC mode based on the configuration data;
receive a pre-allocation request; and
transmit a confirmation signal in response to the pre-allocation request.

13. The device of claim 12, wherein the pre-allocation request is associated with a plurality of dynamic bandwidth transmission opportunities.

14. The device of claim 13, wherein the network management logic is further configured to commit a transfer of data utilizing a dynamic bandwidth transmission mode.

15. The device of claim 14, wherein the transfer of data is configured to occur during the plurality of dynamic bandwidth transmission opportunities.

16. The device of claim 12, wherein the confirmation signal is transmitted to a plurality of network devices.

17. The device of claim 16, wherein the confirmation signal is transmitted to a MAPC coordinator.

18. A method of managing a network, comprising:
forecasting an upcoming congestion period;
selecting a dynamic bandwidth transmission mode;
selecting a plurality of dynamic bandwidth transmission opportunities;
transmitting a schedule to an access point (AP) to pre-allocate the plurality of dynamic bandwidth transmission opportunities;
receiving a confirmation from the AP associated with the schedule; and
transmit data utilizing the selected dynamic bandwidth transmission mode.

19. The method of claim 18, wherein the method further comprises receiving feedback data.

20. The method of claim 19, wherein the method further comprises adjusting one or more parameters based on the feedback data.
